(19) United States
(12) Patent Application Publication
(10) Pub. No.: US 2015/0024332 A1
(43) Pub. Date: Jan. 22, 2015

(54) ANCHOR PLATE IN ORTHODONTICS

(71) Applicant: Bachar TAHA, Hardy Bagneux (FR)

(72) Inventor: Bachar TAHA, Hardy Bagneux (FR)

(21) Appl. No.: 13/947,336

(22) Filed: Jul. 22, 2013

(51) Int. Cl. A61C 8/00

(52) U.S. Cl. CPC A61C 8/0096
USPC 433/2

(57) ABSTRACT

Disclosed is an orthodontics element which may be interdependent of a jaw bone. The orthodontics element includes firstly a plate (1) with a general parallelepipedal shape provided at one end with a first set of orifices and at the other end with a second set of orifices on the one hand, and secondly, between both of these sets, an anchoring block (4) provided with an element for attaching an orthodontics apparatus on the other hand.

### FIELD OF THE INVENTION

The present invention relates to an orthodontics element which is made interdependent of a jawbone.

### BACKGROUND OF THE INVENTION

Certain orthodontic apparatuses have to be maintained in position by anchoring them in a bone of the jaw, such that the anchoring points, although subject to forces developed by these apparatuses, remain stationary. Under these conditions, the solution is that the anchoring points be made interdependent of a bone of the mandibular or maxillary jaw. But no presently applied device is satisfactory.

### SUMMARY OF THE INVENTION

Also, one of the objects of the present invention is to provide an orthodontics element which may be made interdependent of a bone of the jaw.

Another object of the invention is to provide such an element which does not have any drawback notably as regards buccal hygiene and aesthetics.

An additional object of the invention is to provide such an element which may easily be removed at any moment.

These objects, as well as other ones which will become subsequently apparent are achieved with an orthodontics element which may be made interdependent of a bone of the jaw, and which is, according to the present invention, characterized by the fact that it comprises a plate with a general parallelepipedal shape provided at one end with a first set of orifices and at the other end with a second set of orifices on the one hand and, between both of these sets, an anchoring block provided with means for attaching an orthodontics apparatus on the other hand.

According to a first embodiment of the present invention, the attachment means for an orthodontics apparatus system are positioned on one of the free faces of the anchoring block.

Advantageously, the attachment means consist of four studs making open channels between them.

Preferentially, the attachment means for an orthodontics apparatus system are positioned on the face of the anchoring block substantially parallel to the plate.

According to a second embodiment of the present invention, the attachment means consist of a passage made in the anchoring block on the one hand and of an arresting hook positioned on one of the free faces of the anchoring block on the other hand.

Advantageously, the passage is with an axis parallel to the major axis of the plate, and the arresting hook is positioned on one of the side faces of the anchoring block.

### BRIEF DESCRIPTION OF THE DRAWINGS

According to a preferred embodiment, the first set of orifices is formed with a hole and the other set with a U-shaped opening.

The description which will follow and which does not have any limitation, should be read with reference to the appended figures, wherein:

FIG. 1 is a perspective view of a first embodiment of an orthodontics element according to the present invention; and

FIG. 2 is a perspective view of a second embodiment of an orthodontics element according to the present invention.

### DETAILED DESCRIPTION OF THE INVENTION

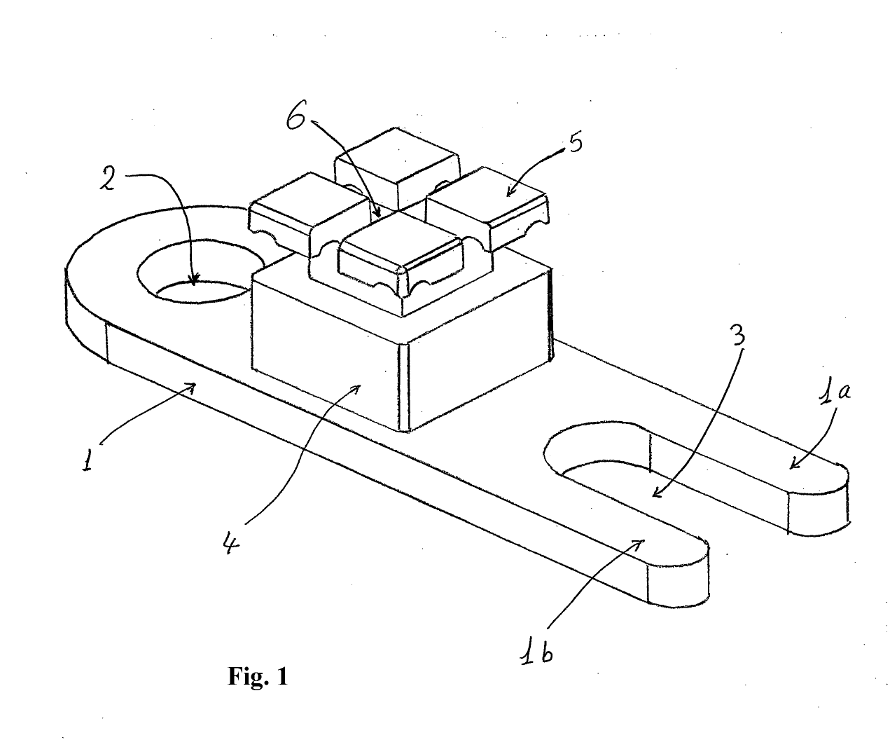

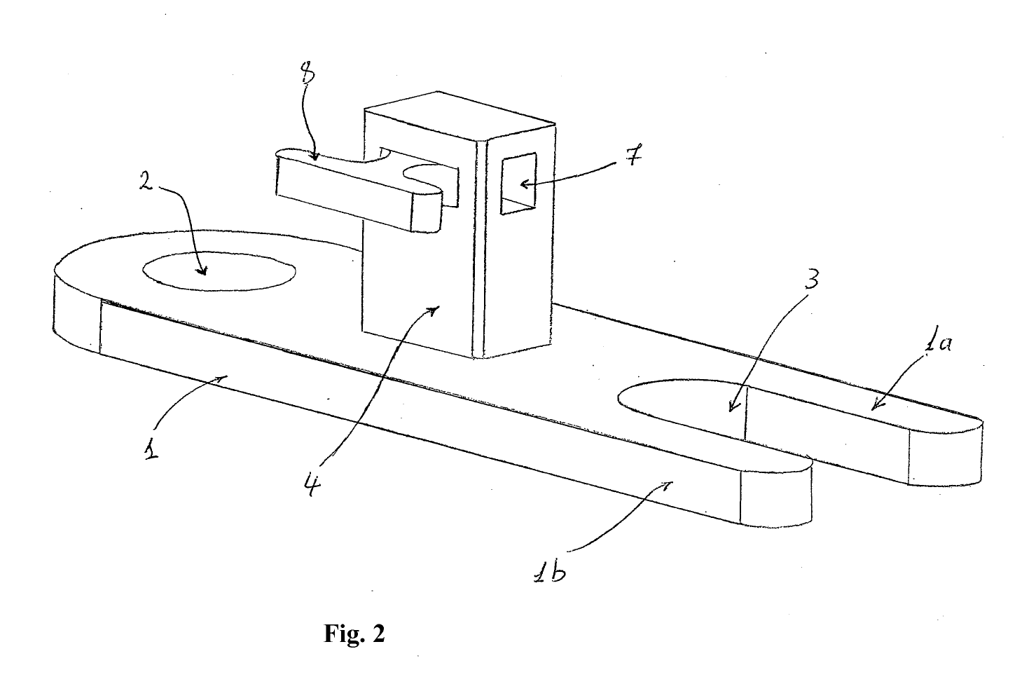

Thus as this may be seen in FIGS. 1 and 2, an orthodontics element according to the present invention firstly comprises a plate 1 with a generally substantial parallelepipedal shape.

At one end, this plate 1 includes a hole 2 for letting through a screw in order to attach this plate on a bone of the jaw.

At its other end, this plate 1 includes a U-shaped opening 3: in other words the plate 1 ends with two parallel branches 1a and 1b delimiting this opening 3, the width of which is substantially equal to the diameter of a screw for attaching this plate 1 on a bone of the jaw.

More generally, this plate 1 may include a first set of orifices instead of a hole 2 and a second set of orifices instead of the U-shaped opening 3.

Secondly, the orthodontics element comprises an anchoring block 4 provided with means for attaching an orthodontics apparatus.

According to a first embodiment illustrated in FIG. 1, the means for attaching an orthodontics apparatus are formed with studs 5 positioned on one of the faces of the anchoring block 4, for example on the face parallel to the plate 1 as illustrated in FIG. 1. For example, these studs 5 are four in number and delimit between them open channels 6, forming a cross. Each stud 5 may include anchoring devices specific for an orthodontics apparatus.

This set of studs 5 and open channels 6 forms what is called a traditional or self-ligating orthodontics tie.

According to a second embodiment illustrated in FIG. 2, the means for attaching an orthodontics apparatus on the anchoring block 4 comprises a passage 7 made in the block, for example along an axis parallel to the major axis of the plate 1 on the one hand and an arresting hook 8 positioned on one of the other faces of the anchoring block 4 on the other hand. Preferably this arresting hook 8 is positioned on a face parallel to the major axis of the plate 1, while the passage 7 is along this major axis as illustrated in FIG. 2.

An orthodontics element according to the present invention may be directly attached on a bone of the jaw, the maxillary or the mandible, without clearing the gum. For this, it is sufficient to introduce a screw into the hole 2 and then another screw into the opening 3 so that none of the two crosses a tooth root. The shape of the opening 3 allows such an adjustment. This orthodontics element may for example be positioned on the external face of the mandible and on the external or internal faces of the maxilla.

In the case when the plate 1 would include two sets of orifices, the screws would be introduced into an orifice of each set so that none of them crosses a tooth root.

The orthodontics element according to the present invention may be rigid, semi-rigid, made in metal and generally in all biocompatible materials.

1. An orthodontics element which may be interdependent of a jaw bone, comprising: a plate (1) with a general parallelepipedal shape provided at one end with a first set of orifices and at the other end with a second set of orifices on the one hand, and between both of these sets, an anchoring block (4) provided with means for attaching an orthodontics apparatus on the other hand.

2. The orthodontics element according to claim 1, wherein the attachment means for an orthodontics apparatus system are positioned on one of the free faces of the anchoring block (4).

3. The orthodontics element according to claim 2, wherein the attachment means consist of four studs (5) making open channels (6) between them.

4. The orthodontics element according to claim 2, wherein the attachment means for an orthodontics apparatus system are positioned on the face of the anchoring block (4) substantially parallel to the plate (1).

5. The orthodontics element according to claim 1, wherein the attachment means consist of a passage (7) made in the anchoring block (4) on the one hand and of an arresting hook (8) positioned on one of the free faces of said anchoring block (4) on the other hand.

6. The orthodontics element according to claim 5, wherein the passage (7) is with an axis parallel to the major axis of the plate (1).

7. The orthodontics element according to claim 6, wherein the arresting hook (8) is positioned on one of the side faces of said anchoring block (4).

8. The orthodontics element according to claim 1, characterized by the fact that the first set of orifices is formed by a hole (2) and the other set by a U-shaped opening (3).

9. The orthodontics element according to claim 2, wherein the first set of orifices is formed by a hole (2) and the other set by a U-shaped opening (3).

10. The orthodontics element according to claim 3, wherein the first set of orifices is formed by a hole (2) and the other set by a U-shaped opening (3).

11. The orthodontics element according to claim 4, wherein the first set of orifices is formed by a hole (2) and the other set by a U-shaped opening (3).

12. The orthodontics element according to claim 5, wherein the first set of orifices is formed by a hole (2) and the other set by a U-shaped opening (3).

13. The orthodontics element according to claim 6, wherein the first set of orifices is formed by a hole (2) and the other set by a U-shaped opening (3).

14. The orthodontics element according to claim 7, wherein the first set of orifices is formed by a hole (2) and the other set by a U-shaped opening (3).
